(19) United States
(12) Patent Application Publication
(10) Pub. No.: US 2021/0124752 A1
(43) Pub. Date: Apr. 29, 2021

(54) System for Data Collection, Aggregation, Storage, Verification and Analytics with User Interface

(71) Applicant: 501Ops, LLC, Dallas, TX (US)

(72) Inventor: Peter Swanson, Dallas, TX (US)

(21) Appl. No.: 17/083,102

(22) Filed: Oct. 28, 2020

Related U.S. Application Data
(60) Provisional application No. 62/927,447, filed on Oct. 29, 2019.

(51) Int. Cl. G06F 16/25; G06F 16/2457

(52) U.S. Cl. CPC G06F 16/254; G06F 16/24573; G06F 16/252; G06F 16/258

(57) ABSTRACT

An apparatus and method are provided for automated collection, aggregation, verification, storage, and export of data. The method includes receiving first data having a first data format, importing the first data into second data having a second data format according to user-defined import rules, and matching the second data to existing data of the system to produce temporary data having a third format. The method further includes displaying to a user of the system the temporary data, receiving from the user change data, the change data specifying changes to one or more elements of the temporary data, and applying the changes specified by the change data to the temporary data to produce modified temporary data. The method also includes exporting the modified temporary data in a user-defined fourth format.

### CROSS-REFERENCE TO RELATED APPLICATIONS

This application claims priority to U.S. Provisional Application No. 62/927,447 filed Oct. 29, 2019 by Peter Swanson entitled, “System for Data Collection, Aggregation, Storage, Verification and Analytics with User Interface”, which is incorporated by reference herein as if reproduced in its entirety.

### TECHNICAL FIELD OF THE DISCLOSURE

The present disclosure relates to a technology platform for the collection of manual data entry; extraction, import or aggregation of unstructured or structured data from various sources; translation and verification based upon the sampling of data fields and system user-defined tiered level of assurance to ascertain probability of accuracy; storage of data; and data analytics including creation of tables, mapping data, and loading of data to platform user interface(s) or other third party application(s).

### BACKGROUND

Data aggregation for the purpose of record retention and analytics has been a complex and time-consuming process. Reasons for the complexity of this process include the required knowledge of a variety of technical coding languages, collection of data from different and dynamic sources that are both unstructured and structured, format inconsistencies, manipulation (translation) of data to import and export to a standard format.

Business intelligence tools, analytic platforms, and disparate third-party applications are powerful tools to assist for-profit businesses and non-profit organizations operation. However, these tools, platforms, and applications rely primarily on the quality and structure of data. Consequently, the current data aggregation and reporting models have required a significant investment in people and technology to increase data accuracy for continuous data management, analytics, and reporting requirements. Currently, there does not exist a platform to assist non-technical and technical individuals to rapidly deploy/maintain a framework to automate or assist in data collection and analytics.

Currently, applications, platforms, and tools exist in the market to perform specific functions for the data collections, verification, storage, and analytics of data. However, in a dynamic data world that requires multiple disparate applications, platforms and tools still require people to perform manual review and manipulation of data for accuracy and consistency. This technique is inefficient in the context of today's reporting requirements, as the needs of each business/nonprofit are dynamic. Consequently, businesses/nonprofits are required to invest large sums of capital and resources on a reoccurring basis in an attempt to conduct timely, accurate, and consistent activities such as data storage, aggregation, verification, analytics, and reporting.

Ownership and access to data within or external to the platform interface with multiple user roles and one individual can represent multiple user profiles based on the orientation of that individual to the contextual situation. All data that is identifiable to a person, nonperson, entity, or other naming classification are platform users. Non-identifiable data is linked to a default system user. Not all platform users will use the system.

### SUMMARY

In a first embodiment, a method for automated collection, aggregation, verification, storage, and export of data includes receiving first data having a first data format, importing the first data into second data having a second data format according to user-defined import rules, and matching the second data to existing data of the system to produce temporary data having a third format. The method further includes displaying to a user of the system the temporary data, receiving from the user change data, the change data specifying changes to one or more elements of the temporary data, and applying the changes specified by the change data to the temporary data to produce modified temporary data. The method also includes exporting the modified temporary data in a user-defined fourth format.

In a second embodiment, an apparatus includes a memory that stores instructions and a processor that executes the instructions. The processor executes the instructions to receive first data having a first data format, import the first data into second data having a second data format according to user-defined import rules, and match the second data to existing data of the system to produce temporary data having a third format. The processor further executes the instructions to display to a user of the apparatus the temporary data, receive from the user change data, the change data specifying changes to one or more elements of the temporary data, and apply the changes specified by the change data to the temporary data to produce modified temporary data. The processor also executes the instructions to export the modified temporary data in a user-defined fourth format.

In a third embodiment, a non-transitory computer-readable medium stores computer instructions that when executed by one or more processors, cause the one or more processors to receive first data having a first data format, import the first data into second data having a second data format according to user-defined import rules, and match the second data to existing data of the system to produce temporary data having a third format. The instructions further cause the one or more processors to display to a user of a system the temporary data, receive from the user change data, the change data specifying changes to one or more elements of the temporary data, and apply the changes specified by the change data to the temporary data to produce modified temporary data. The instructions also cause the one or more processors to export the modified temporary data in a user-defined fourth format.

### BRIEF DESCRIPTION OF THE DRAWINGS

For a more complete understanding of the present disclosure and the advantages thereof, reference is now made to the following description taken in conjunction with the accompanying drawings in which like reference numerals indicate like features and wherein:

FIG. 1 presents a data flow diagram for a system according to the disclosure;

FIG. 2 presents two table structures according to the disclosure;

FIG. 3 presents a method according to the disclosure for importing data;

FIG. 4 presents a method according to the disclosure for defining user matching criteria;

FIG. 5A presents a method according to the disclosure for defining data export format and structure;

FIG. 5B presents an example of a template builder control screen according to the disclosure;

FIG. 6A presents a control screen according to the disclosure for the Red Box formula builder of FIG. 1;

FIG. 6B presents a scheduler control screen according to the disclosure for a formula built using the control screen of FIG. 6A;

FIG. 7 presents a control screen according to the disclosure for the configuration of payments to merchants;

FIG. 8A presents a User Search control screen according to the disclosure;

FIG. 8B presents a User Detail screen according to the disclosure;

FIG. 9 presents system functions according to the disclosure for controlling system configurations and permissions; and

FIG. 10 presents a schematic view of an apparatus for implementing a system according to the disclosure.

### DETAILED DESCRIPTION

We have recognized the need for a single platform to assist businesses/nonprofits to manage and automate activities such as the collection, aggregation, storage, verification, and/or analytics of data. A system according to the disclosure allows data aggregation across multiple platforms and applications, and across multiple businesses and nonprofits, and enables non-technical individuals to tailor the configuration of the process from data collection to analytics, thereby allowing an efficient repeatable process to increase accuracy and to save time and money. Through the establishment of such a platform, the current lack of an efficient or accurate data aggregation, verification, and analysis will be addressed; the time, cost savings, and accurate data is recognized as the value to the individual business/nonprofit and the community. This method establishes a process and infrastructure to manage and leverage a complex data world.

In addition to the single platform to perform activities such as collection, aggregation, verification, storage, and/or analytics of data, a platform user interface and third-party software interface is provided to each business/nonprofit to more easily view and interact with source data. The platform user interface(s) and third-party interfaces are easily and rapidly configured to meet needs such as viewing, editing, deleting, and adding of old and new data.

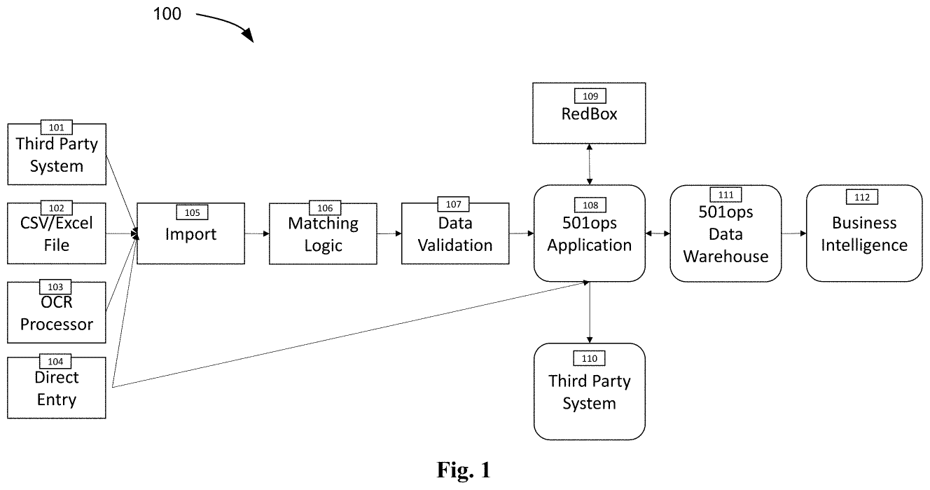

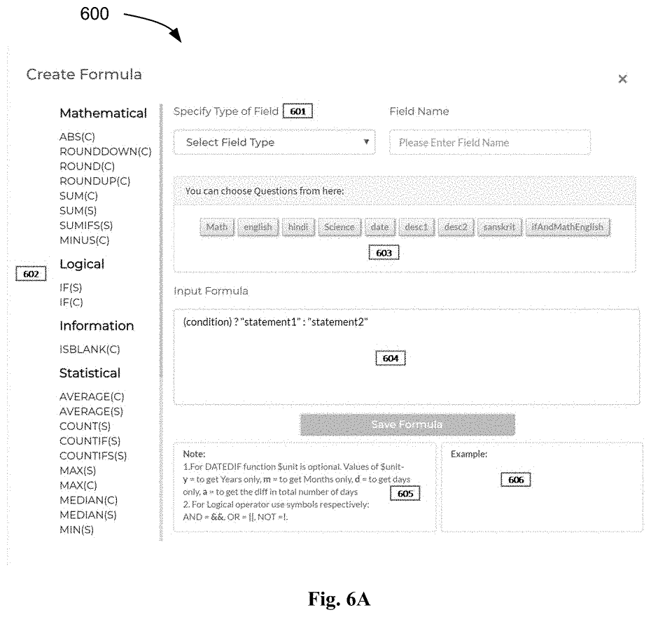

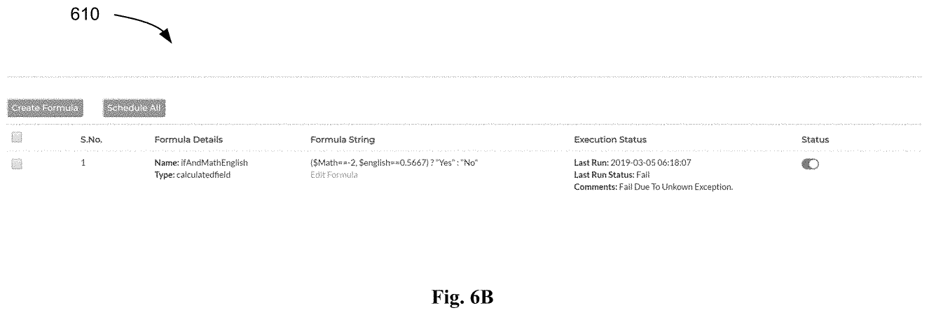

A system according to the disclosure ushers a platform user through the flow of data from the source to analytics and creates a template/process for future data. FIG. 1 presents a data flow diagram 100 for a system according to the disclosure. Data can originate from an Application Programming Interface (API) from a third party platform or application 101, a flat file such as a Comma-Separated Values (CSV) or Excel file 102, an internal process such as Optical Character Recognition (OCR) 103, or direct data entry 104. Third party platform 101, CSV/Excel file 102, and OCR 103 are controlled by an import process 105. Imported data undergoes matching logic 106 and data validation 107 once the import process 105 is initiated and the results are presented as “temporary data” by the application 108. Once the “temporary data” is approved, additional summary or calculated fields can be performed on the data in the Red Box formula builder 109, as described in greater detail with reference to FIGS. 6A and 6B. Data is stored in a data warehouse 111. Additionally, data can be exported to the same or another third-party platform 110, or synced with a business intelligence application 112, internal analytics, or other product for data visualization.

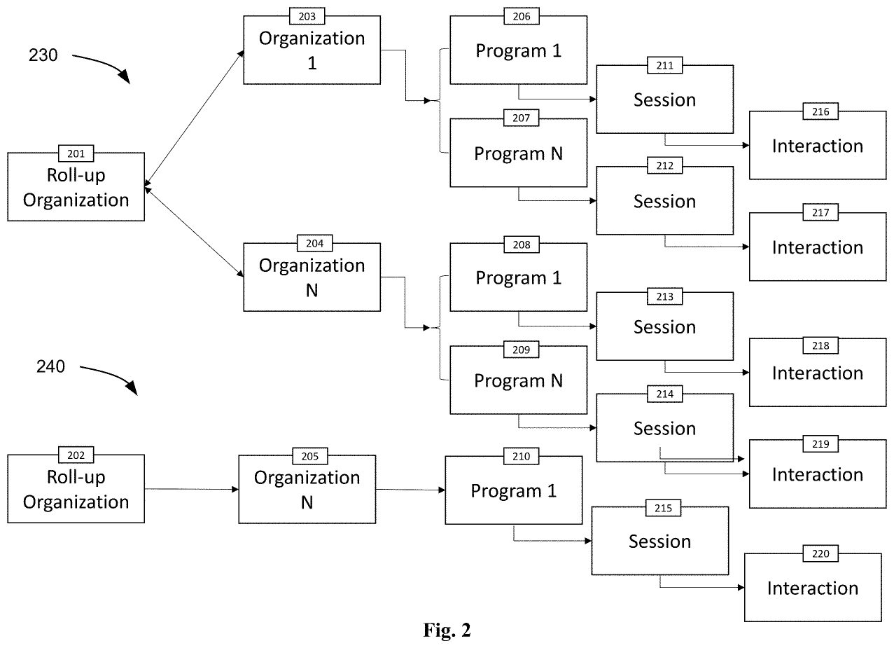

The system according to the disclosure provides the flexibility to create both simple and complex data structures rapidly and with minimal platform user training or supervision. FIG. 2 presents table structures 230 and 240 according to the disclosure. FIG. 2 demonstrates the variability of table structures. Roll-up organizations designated by 201 and 202 have the ability to combine data from any variation of discrete organizations, designated by 203, 204, and 205. Each discrete organization can have a number of “programs” designated by 206, 207, 208, 209, and 210 and limited only by system storage capacity. Program refers to a grouping of tables based on functional area within a business or nonprofit such as funding programs, financial matters, surveys, events, or platform user defined grouping. Each program is capable of multiple sessions defining changes in data structures over time as designated by 211, 212, 213, 214, and 215. Sessions 211 to 215 provide an additional subgrouping of tables. Data is stored in “Interaction” tables denoted by 216, 217, 218, 219, and 220. Each session can have multiple interactions. The combination of Roll-up Organization, Organization, Program, Session, and Interaction can be as simple as a 1:1 relationship or as complex as the total permutation of the subset of grouping and tables.

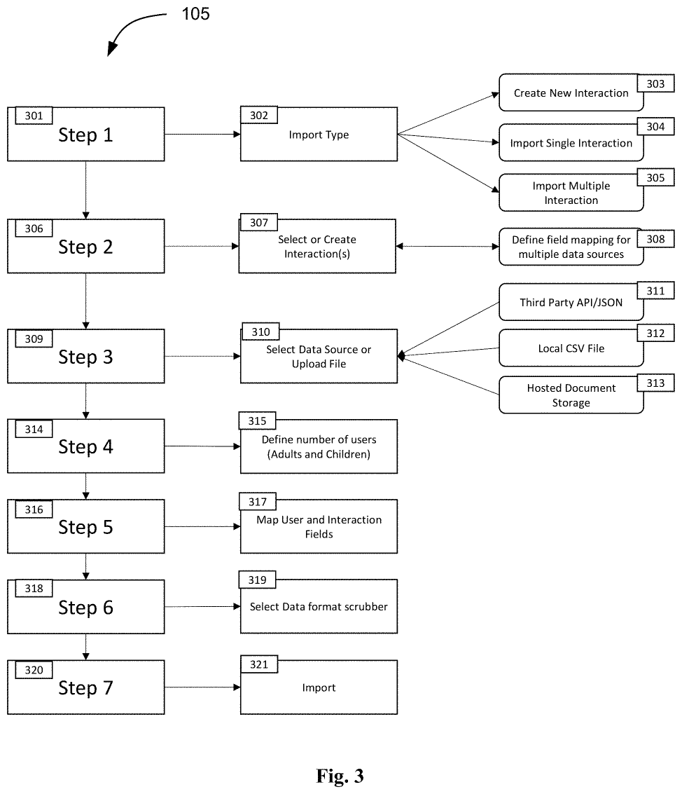

FIG. 3 presents a method 105 according to the disclosure for importing data. The import process 105 noted in FIG. 1 and detailed in FIG. 3 is a process to usher a platform user to bulk load data into the platform. Step 1 (301) defines the type of import 302 as “Creating a New Interaction” 303, “Import Single Interaction” 304, and “Import Multiple Interaction(s)” 305. Process 303 will generate the interaction, process 304 will import data to one existing interaction or table, and process 305 will import data from one source to multiple interactions or interaction tables. Step 2 (306) prompts the platform user to “select or create the interaction” 307. If creating a new interaction 303, the platform user will be prompted to define interaction name in step 307. Additionally, if creating a new interaction 303, the platform user will be prompted to map multiple field names for multiple data sources in step 308. Step 3 (309) prompts the platform user to “select the data source or upload file” 310, with option for a third-party application programming interface (API) or JavaScript object notation (JSON) file 311, a local flat file such as a comma separated values (CSV) file 312, or from the hosted document storage on the server 313.

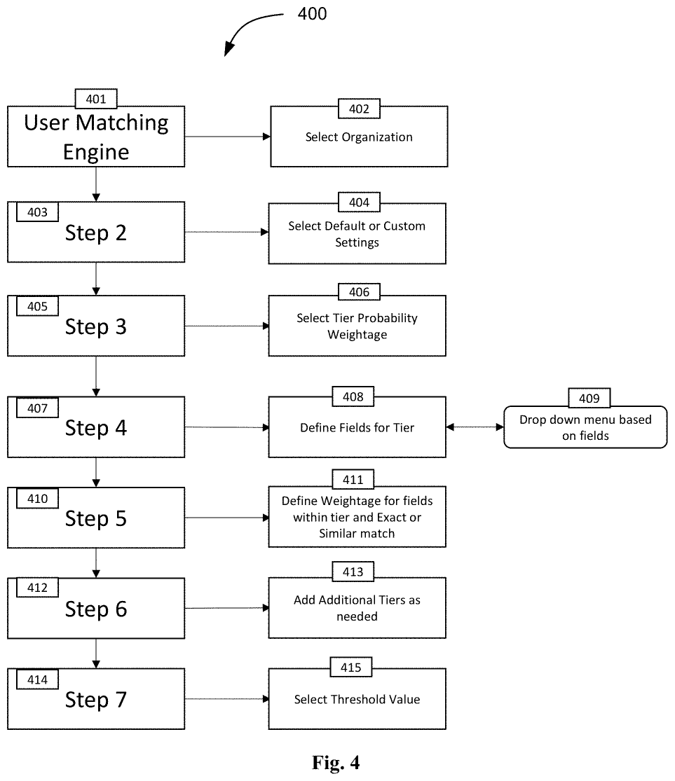

Step 4 (314) prompts the platform user who has sufficient privileges to define the number of client/participant users in a single row of data in step 315. This enables a platform user to import data from sources where multiple client/participant users are presented in a single row of data. Step 5 (316) prompts the platform user to map client/participant User fields and Interaction Fields pertaining to a Client or a Participant user to the system in step 317. Based on the permutation of step 315, the platform user will map fields from the source file to the field in the platform. If a field is not mapped in this step, the field will be created in the interaction. Step 6 (318) allows the platform user to select a data format scrubber in step 319, which formats data into a consistent data structure. This includes capitalization, data formats, integer format, currency format, and custom formats. In Step 7 (320), the platform user presses the import button to begin the importing of data in step 321. In some embodiments, from the import page, platform users can confirm or edit the client/participant “User Matching Engine” 401 (discussed below with reference to FIG. 4). After import is selected (and based on parameters selected), automatic data validation 107 is performed and results are presented as “temporary data” by the application 108 with comments on why data failed the data validation check.

FIG. 4 presents a method 400 according to the disclosure for defining user matching criteria. The method 400 provides a configuration to tailor a client/participant user “User Matching Engine” (401). The User Matching Engine 401 enables a platform user to define the parameters around matching criteria. Each organization and platform user can define and modify the specific matching criteria and store the setting to be run when data is imported or entered into the system. FIG. 4 shows a process for defining the client/participant “User Matching Engine” criteria. The system user first selects (402) which organization the criteria applies to. Step 2 (403) prompts the platform user to select system default settings or create custom settings (404). Step 3 (405) prompts the system user to select a tier probability (406). A tier probability is a series of participant/client user fields, the order of the fields, the exact or partial match of the fields, an assigned weight to such participant/client user field, and the confidence threshold necessary to provide the desired accuracy of the data accumulation. Once established, the tier probability will calculate the probability of accuracy of the data and prompt the user to affirm or modify the input data accordingly. Step 4 (407) prompts the platform user to select defined fields for the tier (408), the fields are presented with a drop-down menu of available fields (409). Step 5 (410) allows the platform user to define the probability weightage for each field and specify an exact match or partial match (411). Step 6 (412) prompts the platform user to add additional tiers (413), if needed, and to repeat Steps 3, 4, and 5 for the new tier(s) (413). Step 7 (414) allows the platform user to select or define (415) a confidence threshold.

Based on the defined parameters, the system will compare imported data records to the internal system data records, calculate the number of potential matching client/participant users or fields and a magnitude of a variance of the imported data to the internal system based upon the platform user-defined thresholds, data field elements, confidence levels for the fields, match of the tier, or subset of fields, and then present the proposed matches to the platform user as temporary data for confirmation or modification before being stored in the system as an internal record. Where the calculated probability equals or exceeds the platform user-defined confidence threshold without an acceptable level of conflict with other potential client/participant user matches of equal or greater probability, the data is merged automatically. Potential duplicate entries are shown in the “temporary data” screen for the platform user to evaluate. If no match is found, the system automatically creates a new client/participant user. The option for a system “default user” allows data to be imported or entered without mapping to a client/participant.

“Temporary Data,” stored in application 108, is a staging table used to perform data validation 107 and the results of user matching. “Temporary Data” will show user matching results, show whether a single client/participant user is identified, show multiple users that have been identified, display client/participant user data, display interaction data, and display comments on the record. If data validation 107 finds errors, an error message will inform the platform user on what failed, and the platform user can edit the data in this screen to meet compliance. If potential multiple client/participant users (duplicates) are identified, a pop-up screen will display the results of the matching logic, a list of all potential client/participant user matches, and prompt the platform user to create a new client/participant user, merge with an existing client/participant user, or use the system default user. If merge client/participant user is selected, the platform user will be prompted to select which data to keep and which data to store in archive. A platform user can either directly import to data warehouse 111 from this screen or select to schedule data loading on the “schedule temporary data” screen. If additional errors occur during this process, data remains in the temporary data screen with comments on why import to data warehouse failed.

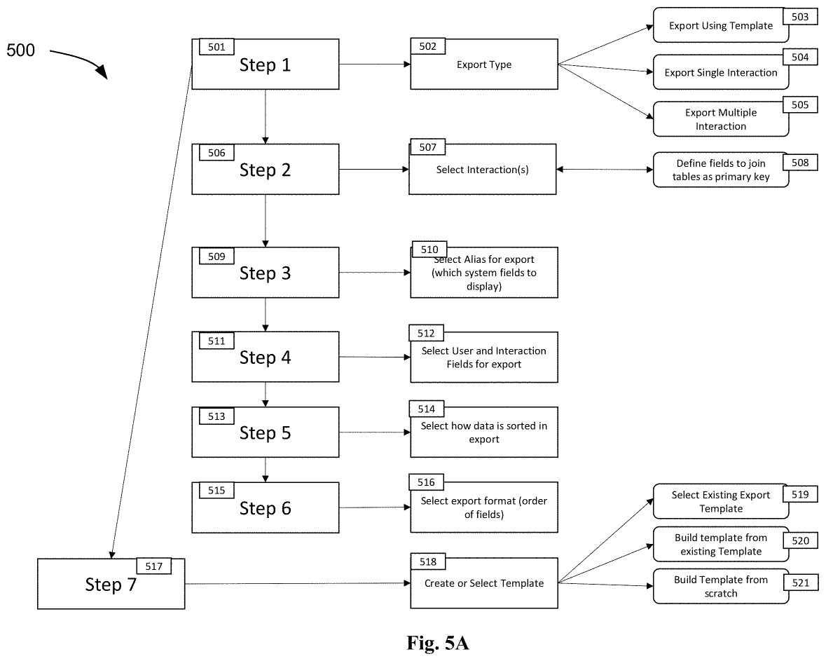

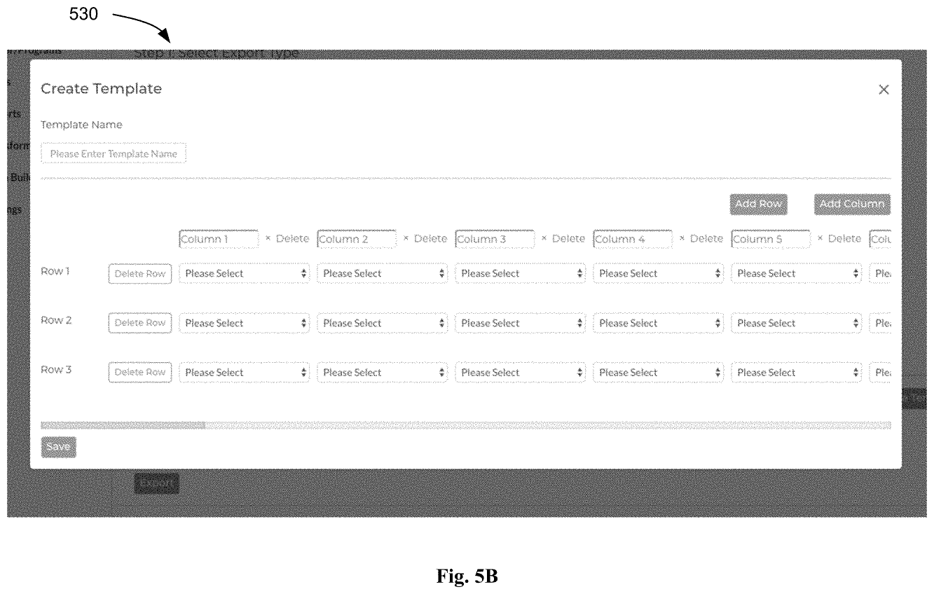

FIG. 5A presents a method 500 according to the disclosure for defining data export format and structure. The platform provides export functions on the “Custom Export” process to both third party platform 110 and business intelligence application 112 (shown in FIG. 1). The purpose of this screen allows the platform user to define the format and structure to export data for loading into another system or for general purpose. Step 1, 501, prompts the platform user to select 502 an “export type”. The platform user can select a process “Export Using Template” 503, “Export Single Interaction” 504, or “Export Multiple Interaction(s)” 505. Process 505 allows the platform user to join multiple tables together for export. Step 2, 506, prompts the platform user to select 507 interaction tables. Process 508 defines a primary key to create a relationship between two tables. Step 3, 509, prompts the platform user to select 510 field alias for export, which enables the export to match fields to the source data of the disposition system, including third party software, business intelligence system, or data ware housing service. Step 4, 511, prompts the platform user to select 512 the user and interaction fields to be included in the export. Step 5, 513, prompts the platform user to select 514 how the data is sorted and/or grouped in the export file. Step 6, 515, prompts the platform user to select 516 the format of the export in regards to field orientation. The platform user can bypass Steps 2-6 and go directly from Step 1 to Step 7, 517. In Step 7, the platform user will be prompted to create or select 518 a template for export. Platform user can either select 519 an existing template, build 520 a template from an existing template, or build 521 a template from scratch. A template builder control screen according to the disclosure for use in step 520 or 521 may show a grid and allow the platform user to define where fields are positioned on the grid. This enables complex translation of data in row and column format. An example of such a template builder control screen 530 according to the disclosure is presented in FIG. 5B.

The “Red Box” formula builder 109 is a process and formula builder to enable the platform user to define calculated fields (write data into a row) or summary fields (query results). Calculated fields and summary fields are structured query language (SQL) based queries, and the user interface allows a platform user to build, schedule, and modify SQL queries without needing to know SQL. Formulas are scheduled by the platform user to run in a sequence on a recurring basis. FIG. 6A presents a control screen 600 according to the disclosure for the Red Box formula builder 109 of FIG. 1. Control 601, prompts the platform user to specify whether a field is calculated or summary. Control 602 shows the available operators and functions available. Clicking on an operator or function causes the syntax for the formula to be presented in the Input Formula field 604. Control 603 shows the available fields for the interaction tables, and further defines the type and operator/function, and by clicking on the field name will imbed the field into the formula builder in the Input Formula field 604. Field 605 shows additional syntax help for the function, and the platform user can click in this field to add notes about how they build the formula. Field 606 shows examples of the formula generated by the system based upon platform user input.

FIG. 6B presents a scheduler control screen 610 according to the disclosure for a formula built using the control screen 600 of FIG. 6A. Control 607 prompts the platform user to create a new formula. Control 608 prompts the platform user to schedule when the formula will run. Column 609 shows the formula and provides a control to allow the platform user to edit the formula. Column 610 shows when the formula was last run, the status of that run, and comments about the status of the run. Control 611 allows the platform user to activate or deactivate formulas.

Systems according to the disclosure include a form builder to enable a platform user to create import and output forms for the purpose of manual data entry (Direct [data] Entry 104, FIG. 1). Input forms are web-based data entry screens to be used within the platform or external to the platform. Output forms allow the platform user to create or tailor web-based screens for viewing and editing data within the system. Platform users can use the form builder to edit the visual presentation of screens. Input forms can be manually created or autogenerated based on interactions or client/participant user fields. Input forms can be edited using a platform user interface of the form builder, to control the styling of the form. After creating the form, the platform user can match the input fields to the interaction fields in the data warehouse and application. Additionally, the platform user can define data mapping to email templates, to cause auto-generation of emails to be sent after submission of an input form. Once an input or export form is generated, a uniform resource locator (URL) is auto-generated for the form, to be a standalone webpage or embedded in an external webpage.

The platform has an associated data warehouse (111, FIG. 1). Once data has been processed through the application 108, it is synced and schedule to be inserted, updated, or deleted in the data warehouse. The data warehouse 111 is connected directly to external applications such as business intelligence application 112 as the Master Data Management data source, to insure data fidelity and proper data storage format. Each session and interaction has a scheduler to control when data is synced between the application 108 and the data warehouse 111. Sync status is displayed in the application 108 under a RPT-Gen Status tab.

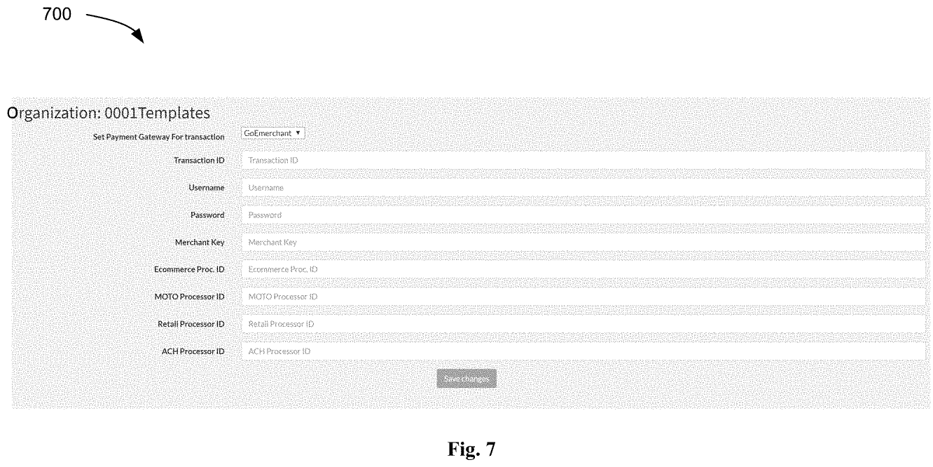

In some systems according to the disclosure, merchant processing integration is embedded into the platform. FIG. 7 presents a control screen 700 according to the disclosure for the configuration of payments to merchants. Pop up menu 701 enables the platform user to select the merchant processor. Fields 702 allow the platform user to provide merchant processor configuration information to embed within the platform. Once configured, payment forms can be embedded into input forms where transaction data is stored in an interaction and facilitates the transaction with the selected merchant processor.

In other systems according to the disclosure, the platform has multiple features for the interaction. In addition to creating interaction tables through the import process (FIG. 3), a platform user can manually create interaction fields on the interaction screen or create from a template. Platform users can define field types and parameters for each field. Fields can be displayed in multiple languages such as (but not limited to) English and Spanish. The platform has a “Multi-Edit” screen for interaction data that shows the grid view of all data within the table, and allows the platform user to mass edit data within the table. Platform users can pull individual records through the data list tab. Platform users can delete interaction and delete interaction data.

In still other systems according to the disclosure, the platform allows the platform user to embed dashboards into the home screen with single sign on (SSO) with third party business intelligence applications. Platform users can also pull data extracts through Simple Reports or using the custom export process (as described with reference to FIGS. 5A and 5B).

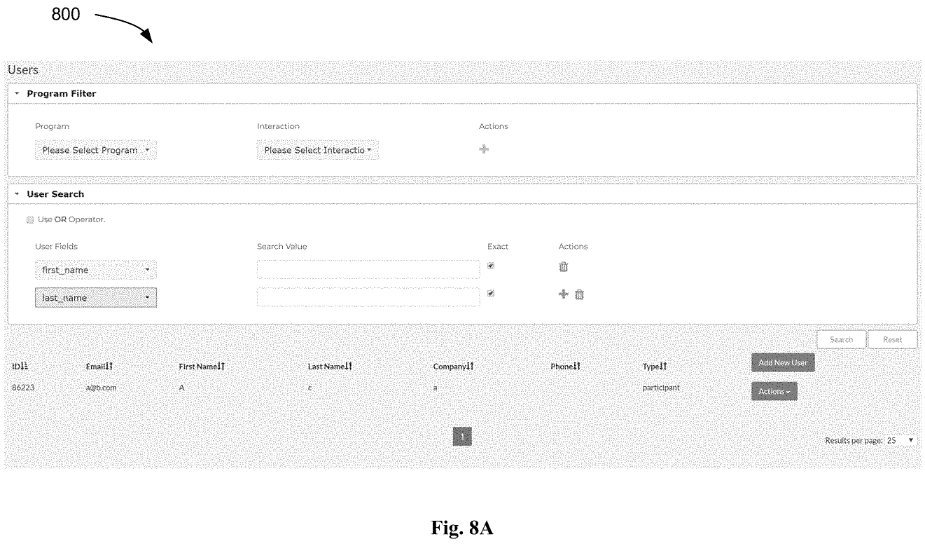

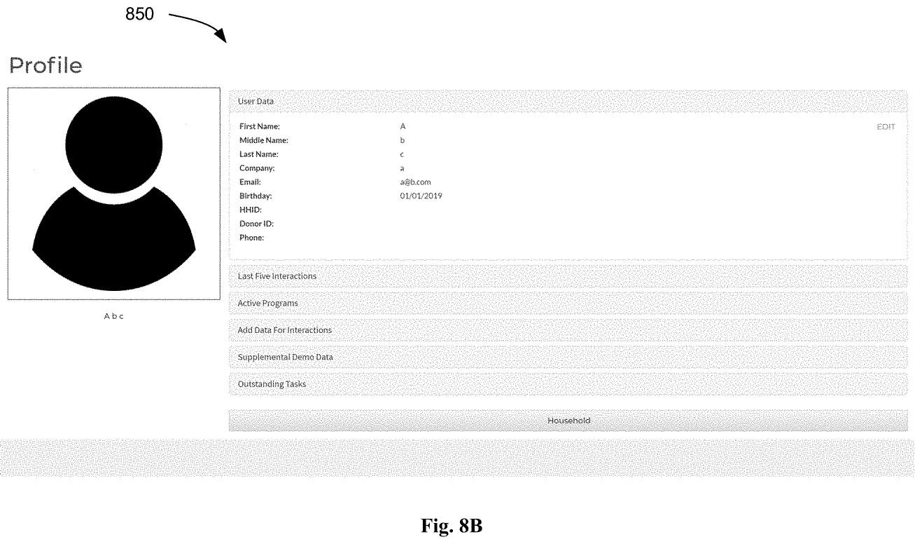

The platform provides a user interface that allows platform users to define what platform or client/participant user(s) to view, edit, delete, and add new data through the user detail page. FIG. 8A presents a User Search control screen 800 according to the disclosure to control the user search function to find records in the data warehouse 111. Controls 801 allow the platform user to search based on a selected program 802, and a selected interaction 803. The platform user can add additional parameters, such as interaction tables, using control 804. Additionally, a platform user can search by client/participant user using controls 805. Search fields can be added and selected at 806. Search values for selected fields can be specified at 807, allowing for an exact search or a partial search. Fields can be added or deleted using control 808. Results are displayed below the controls 801 and 802, and User Detail can be accessed using control 809.

New users can be added from the screen illustrated in FIG. 8A as well. FIG. 8B presents a User Detail screen 850 according to the disclosure that summarizes data based on a user or entity. (The page is formatted with accordion tabs to allow for a user to quickly navigate to the intended target (in this case, information about the user). In other embodiments, other suitable display controls that enable easy access to an intended target may be provided. General user data is displayed in fields 810, which can be made editable using control 811. Accordion tab 812 displays the last 5 interactions with a link to the data and a link to access all interactions. “Active Programs” 813 displays information relating to active programs, where interaction data is presented. Accordion tab 814 displays a list of data entry screens under “Add Data for Interaction,” enabling the user to access a desired data entry screen quickly. “Supplemental Demo Data” 815 displays a section unique to each organization, including global information, non-transactional data collected on each user that is unique to each organization, and additional to system wide user data. This section functions similarly to user data 810. “Outstanding Tasks” 816 allows platform users to create a log of action items to be completed for the participant. A visual map of how participants are related to each other is found on the Household tab 817, with links to user detail pages of associated users.

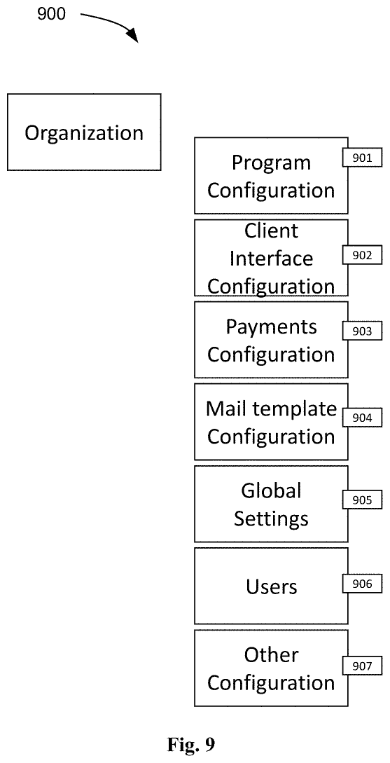

FIG. 9 presents system functions 900 according to the disclosure for controlling system configurations and permissions. The platform provides System Configurations and Permissions, as shown in the user interaction block diagram of FIG. 9. Data structure is configured through Programs block 901; and user detail page and dashboard links are controlled and linked in block 902. Payment configuration is specified in block 903, email templates in block 904, global settings in block 905, user settings and permissions in block 906, and other configuration information in block 907. Through the user tab in block 906, system permissions are controlled to enable what sections and data (view, edit, delete, add) are available to each system user and participant. Logs of user activities are monitored for each system user and participant.

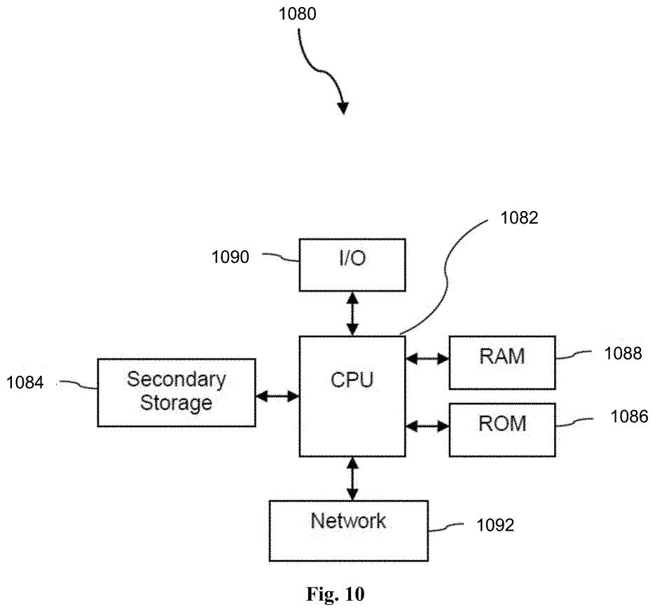

FIG. 10 illustrates a computer system 1080 suitable for implementing one or more embodiments disclosed herein. For example, the computer system 1080 is suitable for implementing at least steps 104-109 and 111 of the method 100 described with reference to FIG. 1. The computer system 1080 includes a processor 1082 (which may be referred to as a central processor unit or CPU) that is in communication with memory devices including secondary storage 1084, read only memory (ROM) 1086, random access memory (RAM) 1088, input/output (I/O) devices 1090, and network connectivity devices 1092. The processor 1082 may be implemented as one or more CPU chips.

It is understood that by programming and/or loading executable instructions onto the computer system 1080, at least one of the CPU 1082, the RAM 1088, and the ROM 1086 are changed, transforming the computer system 1080 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 1080 is turned on or booted, the CPU 1082 may execute a computer program or application. For example, the CPU 1082 may execute software or firmware stored in the ROM 1086 or stored in the RAM 1088. In some cases, on boot and/or when the application is initiated, the CPU 1082 may copy the application or portions of the application from the secondary storage 1084 to the RAM 1088 or to memory space within the CPU 1082 itself, and the CPU 1082 may then execute instructions that the application is comprised of. In some cases, the CPU 1082 may copy the application or portions of the application from memory accessed via the network connectivity devices 1092 or via the I/O devices 1090 to the RAM 1088 or to memory space within the CPU 1082, and the CPU 1082 may then execute instructions that the application is comprised of. During execution, an application may load instructions into the CPU 1082, for example load some of the instructions of the application into a cache of the CPU 1082. In some contexts, an application that is executed may be said to configure the CPU 1082 to do something, e.g., to configure the CPU 1082 to perform the function or functions promoted by the subject application. When the CPU 1082 is configured in this way by the application, the CPU 1082 becomes a specific purpose computer or a specific purpose machine.

The secondary storage 1084 is typically comprised of one or more disk drives or tape drives and is used for non-volatile storage of data and as an over-flow data storage device if RAM 1088 is not large enough to hold all working data. Secondary storage 1084 may be used to store programs which are loaded into RAM 1088 when such programs are selected for execution. The ROM 1086 is used to store instructions and perhaps data which are read during program execution. ROM 1086 is a non-volatile memory device which typically has a small memory capacity relative to the larger memory capacity of secondary storage 1084. The RAM 1088 is used to store volatile data and perhaps to store instructions. Access to both ROM 1086 and RAM 1088 is typically faster than to secondary storage 1084. The secondary storage 1084, the RAM 1088, and/or the ROM 1086 may be referred to in some contexts as computer readable storage media and/or non-transitory computer readable media.

I/O devices 1090 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 1092 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 1092 may provide wired communication links and/or wireless communication links (e.g., a first network connectivity device 1092 may provide a wired communication link and a second network connectivity device 1092 may provide a wireless communication link). Wired communication links may be provided in accordance with Ethernet (IEEE 802.10), Internet protocol (IP), time division multiplexing (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), Wi-Fi (IEEE 802.11), Bluetooth, ZigBee, narrowband Internet of things (NB IoT), near field communications (NFC), and radio frequency identification (RFID). The radio transceiver cards may promote radio communications using 5G, 5G New Radio, or 5G LTE radio communication protocols. These network connectivity devices 1092 may enable the processor 1082 to communicate with the Internet or one or more intranets. With such a network connection, it is contemplated that the processor 1082 might receive information from the network, or might output information to the network in the course of performing the above-described method steps. Such information, which is often represented as a sequence of instructions to be executed using processor 1082, may be received from and outputted to the network, for example, in the form of a computer data signal embodied in a carrier wave.

Such information, which may include data or instructions to be executed using processor 1082 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 1082 executes instructions, codes, computer programs, scripts which it accesses from hard disk, floppy disk, optical disk (these various disk based systems may all be considered secondary storage 1084), flash drive, ROM 1086, RAM 1088, or the network connectivity devices 1092. While only one processor 1082 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 1084, for example, hard drives, floppy disks, optical disks, and/or other device, the ROM 1086, and/or the RAM 1088 may be referred to in some contexts as non-transitory instructions and/or non-transitory information.

In an embodiment, the computer system 1080 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 1080 to provide the functionality of a number of servers that is not directly bound to the number of computers in the computer system 1080. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 1080, at least portions of the contents of the computer program product to the secondary storage 1084, to the ROM 1086, to the RAM 1088, and/or to other non-volatile memory and volatile memory of the computer system 1080. The processor 1082 may process the executable instructions and/or data structures in part by directly accessing the computer program product, for example by reading from a CD-ROM disk inserted into a disk drive peripheral of the computer system 1080. Alternatively, the processor 1082 may process the executable instructions and/or data structures by remotely accessing the computer program product, for example by downloading the executable instructions and/or data structures from a remote server through the network connectivity devices 1092. The computer program product may comprise instructions that promote the loading and/or copying of data, data structures, files, and/or executable instructions to the secondary storage 1084, to the ROM 1086, to the RAM 1088, and/or to other non-volatile memory and volatile memory of the computer system 1080.

In some contexts, the secondary storage 1084, the ROM 1086, and the RAM 1088 may be referred to as a non-transitory computer readable medium or a computer readable storage media. A dynamic RAM embodiment of the RAM 1088, likewise, may be referred to as a non-transitory computer readable medium in that while the dynamic RAM receives electrical power and is operated in accordance with its design, for example during a period of time during which the computer system 1080 is turned on and operational, the dynamic RAM stores information that is written to it. Similarly, the processor 1082 may comprise an internal RAM, an internal ROM, a cache memory, and/or other internal non-transitory storage blocks, sections, or components that may be referred to in some contexts as non-transitory computer readable media or computer readable storage media.

What is claimed is:

1. A method for automated collection, aggregation, verification, storage, and export of data, the method comprising:
receiving first data having a first data format;
importing the first data into second data having a second data format according to user-defined import rules;
matching the second data to existing data of the system to produce temporary data having a third format;
displaying to a user of the system the temporary data;
receiving from the user change data, the change data specifying changes to one or more elements of the temporary data;
applying the changes specified by the change data to the temporary data to produce modified temporary data;
exporting the modified temporary data in a user-defined fourth format.

2. The method of claim 1, further comprising storing the modified temporary data.

3. The method of claim 1, further comprising further modifying the modified temporary data using user-defined calculations or query results.

4. An apparatus, comprising:
a memory configured to store instructions; and
a processor coupled to the memory and configured to execute the instructions to:
receive first data having a first data format;
import the first data into second data having a second data format according to user-defined import rules;
match the second data to existing data of the system to produce temporary data having a third format;
display to a user of the apparatus the temporary data;
receive from the user change data, the change data specifying changes to one or more elements of the temporary data;
apply the changes specified by the change data to the temporary data to produce modified temporary data;
export the modified temporary data in a user-defined fourth format.

5. The apparatus of claim 4, wherein the processor is further configured to execute the instructions to store the modified temporary data.

6. The apparatus of claim 4, wherein the processor is further configured to execute the instructions to further modify the modified temporary data using user-defined calculations or query results.

7. A non-transitory computer-readable medium storing computer instructions that when executed by one or more processors, cause the one or more processors to:
receive first data having a first data format;
import the first data into second data having a second data format according to user-defined import rules;
match the second data to existing data of the system to produce temporary data having a third format;
display to a user of the system the temporary data;
receive from the user change data, the change data specifying changes to one or more elements of the temporary data;
apply the changes specified by the change data to the temporary data to produce modified temporary data;
export the modified temporary data in a user-defined fourth format.

8. The non-transitory computer-readable medium of claim 7, wherein the processor is further configured to execute the instructions to store the modified temporary data.

9. The non-transitory computer-readable medium of claim 7, wherein the processor is further configured to execute the instructions to further modify the modified temporary data using user-defined calculations or query results.
